(19) United States
(12) Patent Application Publication
(10) Pub. No.: US 2008/0272183 A1
(43) Pub. Date: Nov. 6, 2008

(54) Apparatus for repairing or reinforcing containers

(76) Inventor: David Scott Dumas, San Rafael, CA (US)

Correspondence Address: MURABITO, HAO & BARNES, LLP, TWO NORTH MARKET STREET, THIRD FLOOR, SAN JOSE, CA, 95113, US

(21) Appl. No.: 11/800,253

(22) Filed: May 3, 2007

(51) Int. Cl. B32B 3/26

(52) U.S. Cl. 229/206; 428/63

(57) ABSTRACT

Various solutions for repairing and reinforcing containers are disclosed. Embodiments of the present invention provide patches or reinforcing members which may be conveniently and effectively adhered to a container to improve the structural integrity thereof, protect the contents of the container, and provide an aesthetically-pleasing repair/reinforcement of the container. A substantially-planar patch may be used to repair or reinforce a surface of a container, while patches for adhering to multiple surfaces of the container may be used to repair or reinforce edges or corners. The thickness of the patch may be substantially less than that of its other dimensions to provide a low-profile repair or reinforcement, thereby reducing subsequent damage to the container caused by snagging or catching the patch on external objects. Additionally, the adhesive may bond the patch to the container to reduce separation and withstand loadings imparted to the container.

### BACKGROUND OF THE INVENTION

Many items are damaged or lost each year as a result of damage to their shipping containers. Damage typically occurs during the numerous transfers of the shipping container between delivery vehicles and shipping/receiving locations, where each transfer subjects the shipping container to many types of damage. For example, shipping containers are often dropped and tossed during a transfer, which can cause ruptures, punctures, deformation and other types of damage. Additionally, contact with sharp objects during a transfer can rip, tear, puncture, or otherwise damage the shipping container.

In an attempt to salvage the shipping container for the remainder of the delivery, packing tape is often applied to the damaged area. However, packing ape is prone to separation from the outside of most shipping containers and is not mechanically robust (e.g., easily sliced, torn, punctured, deflected, etc.). As such, the application of packing tape to a damaged shipping container fails to improve the structural integrity of the shipping container, and also fails to protect the contents of the shipping container. Further, packing tape does not produce an aesthetically-pleasing repair, which is important to many recipients and reflects poorly on both the carrier and the sender.

Alternatively, some shippers repackage the goods into a new container when the old container becomes damaged. However, this is a costly solution as repackaging is labor intensive and new shipping containers can be expensive.

### SUMMARY OF THE INVENTION

Accordingly, a need exists to improve the structural integrity of damaged shipping containers. A need also exists to protect the contents of damaged shipping containers. Additionally, a need exists to provide aesthetically-pleasing and economical repairs for damaged shipping containers. Embodiments of the present invention provide novel solutions to these needs and others as described below.

Embodiments of the present invention are directed to various solutions for repairing and reinforcing containers. More specifically, embodiments of the present invention provide patches or reinforcing members which may be conveniently and effectively adhered to a container (e.g., a shipping container, storage container, display container, etc.) to improve the structural integrity thereof, protect the contents of the container, and provide an aesthetically-pleasing repair/reinforcement of the container. A substantially-planar patch may be used to repair or reinforce a surface of a container, while patches for adhering to multiple surfaces of the container may be used to repair or reinforce edges or corners. The thickness of the patch may be substantially less than that of its other dimensions to provide a low-profile repair or reinforcement, thereby reducing subsequent damage to the container caused by snagging or catching the patch on external objects. Additionally, the adhesive may bond the patch to the container to reduce separation and withstand loadings (e.g., tensile, compression, impact, etc.) imparted to the container, where the adhesive may comprise a pressure-sensitive adhesive, a thermoplastic adhesive, a contact adhesive, a drying adhesive, a chemical-curing adhesive, or a photochemical-curing adhesive. Further, the patches may come in various shapes, sizes, colors, etc., depending upon the damage and/or characteristics (e.g., color, material, shape, size, etc.) of the container to be repaired or reinforced.

In one embodiment, an apparatus includes a substantially planar structural member comprising a surface for coupling with a container. Adhesive is disposed on the surface for coupling the substantially planar structural member to the container. The substantially planar structural member is operable to overlap a damaged portion of the container and further operable to improve the structural integrity of the container. The adhesive may comprise at least one of dispersed particles and reinforcing fibers. Further, at least one edge of the substantially planar structural member may comprise a beveled surface (e.g., to reduce subsequent damage to the container caused by snagging or catching the patch on external objects). The apparatus may also include a removable backing disposed on the adhesive for removal prior to application to the container.

In another embodiment, an apparatus includes a structural member comprising at least one surface for coupling with at least two surfaces of a container. Adhesive is disposed on the at least one surface for coupling the structural member to the container. The structural member is operable to overlap a damaged portion of the container and further operable to improve the structural integrity of the container. The damaged portion may comprise an edge of the container. Alternatively, the damaged portion may comprise a corner of the container. The adhesive may comprise at least one of dispersed particles and reinforcing fibers. Further, at least one edge of the structural member may comprise a beveled surface (e.g., to reduce subsequent damage to the container caused by snagging or catching the patch on external objects). The apparatus may also include a removable backing disposed on the adhesive for removal prior to application to the container.

In yet another embodiment, a container includes a housing operable to store one or more items therein, where the housing includes at least one portion. A patch is coupled to the housing and overlaps the portion for improving the structural integrity of the housing, wherein the patch comprises adhesive disposed on a structural member for coupling the structural member to at least one surface of the housing. The portion may comprise a damaged portion of the housing. The portion may include at least one of a surface, an edge, and a corner of the housing. Additionally, the structural member may include at least one bend for conforming to the housing. At least one edge of the structural member may include a beveled surface. And further, the housing may include at least one of cardboard, polymer, ligneous material, and a non-metallic material.

And in another embodiment, an apparatus includes a structural member comprising at least one surface for coupling with at least two surfaces of a container. Adhesive is disposed on the at least one surface for coupling the structural member to the container. The structural member is operable to overlap a portion of the container and further operable to improve the structural integrity of the container. The portion may comprise an edge of the container. Alternatively, the portion may comprise a corner of the container. Further, at least one edge of the structural member may comprise a beveled surface (e.g., to reduce subsequent damage to the container caused by snagging or catching the patch on external objects). The apparatus may also include a removable backing disposed on the adhesive for removal prior to application to the container.

### BRIEF DESCRIPTION OF THE DRAWINGS

The present invention is illustrated by way of example, and not by way of limitation, in the figures of the accompanying drawings and in which like reference numerals refer to similar elements.

FIG. 1A shows an exemplary surface patch for repairing or reinforcing a container in accordance with one embodiment of the present invention.

FIG. 1B shows an exemplary surface patch with an adhesive backing for repairing or reinforcing a container in accordance with one embodiment of the present invention.

FIG. 2 shows an exemplary surface patch applied to a container in accordance with one embodiment of the present invention.

FIG. 3A shows a cross-section of an exemplary surface patch applied to a surface of a container in accordance with one embodiment of the present invention.

FIG. 3B shows a cross-section of an exemplary surface patch applied to a punctured surface of a container in accordance with one embodiment of the present invention.

FIG. 4 shows a cross-section of an exemplary beveled edge of a patch for repairing or reinforcing a container in accordance with one embodiment of the present invention.

FIG. 5 shows an exemplary edge patch for repairing or reinforcing a container in accordance with one embodiment of the present invention.

FIG. 6 shows an exemplary edge patch applied to a container in accordance with one embodiment of the present invention.

FIG. 7A shows a cross-section of an exemplary patch applied to an edge or corner of a container in accordance with one embodiment of the present invention.

FIG. 7B shows a cross-section of an exemplary patch applied to a punctured edge or corner of a container in accordance with one embodiment of the present invention.

FIG. 8A shows exemplary edge patches for supporting straps applied to a container in accordance with one embodiment of the present invention.

FIG. 8B shows exemplary edge patches for supporting straps applied to multiple containers in accordance with one embodiment of the present invention.

FIG. 9 shows an exemplary corner patch for repairing or reinforcing a container in accordance with one embodiment of the present invention.

FIG. 10 shows an exemplary corner patch applied to a container in accordance with one embodiment of the present invention.

FIG. 11A shows exemplary corner patches for supporting straps applied to a container in accordance with one embodiment of the present invention.

FIG. 11B shows exemplary corner patches for supporting straps applied to multiple containers in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and the like have not been described in detail so as not to unnecessarily obscure aspects of the present invention.

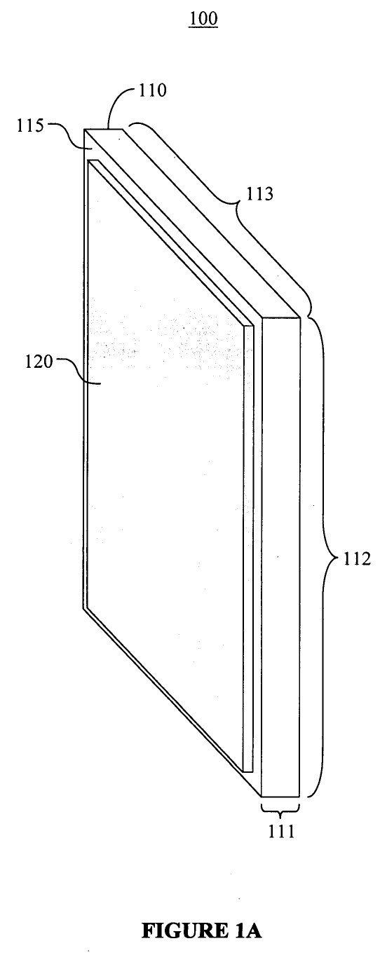

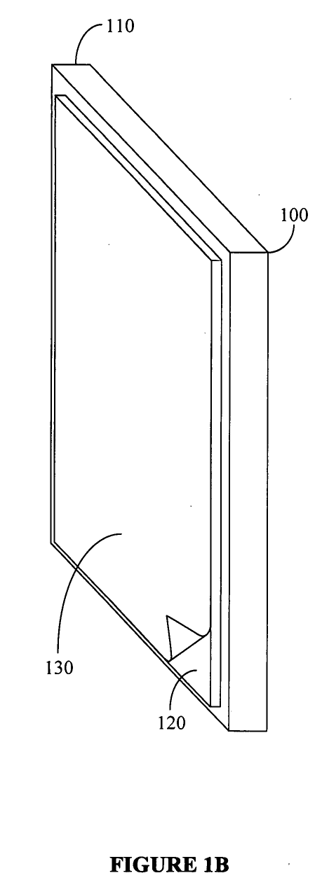

FIG. 1A shows an exemplary surface patch for repairing or reinforcing a container in accordance with one embodiment of the present invention. As shown in FIG. 1A, exemplary surface patch 100 comprises structural member 110 with surface 115 for mating with a surface (e.g., a damaged surface, weakened surface, surface to be reinforced, etc.) of a shipping container, storage container, display container, or other container. Structural member 110 may be substantially flat in one embodiment. Adhesive 120 is disposed on surface 115 for bonding structural member 110 to the container, thereby reinforcing and improving the structural integrity of the container (e.g., by limiting movement of one or more portions of the container with respect to one another in one or more directions). Additionally, patch 100 may at least partially cover damaged areas to protect the contents of the container from damage (e.g., from external objects that may penetrate the container, etc.) and/or loss (e.g., through openings created by damage to the container). Further, by at least partially concealing damage to a container, patch 100 may improve the aesthetics of a damaged container.

As depicted in FIG. 1A, patch 100 may comprise a low-profile for reducing subsequent damage to the container caused by snagging or catching patch 100 on external objects. For example, height or thickness 111 of patch 100 may be substantially less than width 112 and/or length 113. As such, external objects (e.g., rollers or sorting/routing mechanisms at shipping/receiving locations, floors or features of delivery vehicles, other containers, etc.) that the container may encounter can pass over or by patch 100 instead of catching or snagging patch 100, thereby reducing damage to the patch (e.g., 100) and/or further damage the container.

Structural member 110 may comprise paper-based material (e.g., cardboard, cardstock, pressboard, etc.), ligneous material (e.g., wood, faux wood, etc.), metal, polymer, composite material (e.g., sheet molded composite (SMC), fiber reinforced composites, etc.), or any combination thereof. Alternatively, structural member 110 may comprise any material providing physical properties (e.g., tensile strength, impact strength, hardness, flexibility, brittleness, etc.) sufficient for withstanding various types of loadings (e.g., tensile, compression, impact, etc.) imparted to the container (e.g., during transportation, handling, etc.).

Structural member 110 may comprise different shapes, sizes, colors, etc., thereby offering convenient and effective means for repairing or reinforcing various types of containers regardless of appearance and/or type/extent of damage, weakening, etc. In one embodiment, the color scheme of member 110 may match, coordinate with, etc., one or more containers. For example, member 110 may comprise a brown color for application to cardboard containers. Alternatively, member 110 may comprise a predetermined color scheme (e.g., specified by users, etc.). Additionally, patch 100 may comprise one or more areas designated for advertising or other communications. For example, structural member 110 may comprise the name, logo, colors, etc., of a person or entity applying the patch, thereby providing means for an aesthetic repair/reinforcement as well as an advertising opportunity for the user of the patch, a third-party, etc. And in other embodiments, patch 100 may provide one or more areas for messages (e.g., from a carrier repairing or reinforcing a container to the recipient of the shipping container, to customers for informational or advertising purposes, etc.) to be written.

As shown in FIG. 1A, adhesive 120 may comprise any adhesive capable of bonding structural member to 110 to a container, where the bond is sufficient to withstand loadings imparted to the container (e.g., during transportation, handling, etc.). For example, adhesive 120 may comprise a pressure-sensitive adhesive which may bond to the container upon contact with patch 100 and/or upon application of pressure to patch 100 to press it against the container. In one embodiment, HB Fuller HL-2203 may be used to adhere the patch (e.g., 100, etc.) to the container. Alternatively, a thermoplastic adhesive (e.g., hot melt adhesives which harden upon cooling, etc.) may be used to bond structural member 110 to the container. Adhesive 120 may comprise a contact adhesive which is operable to bond to an adhesive disposed on the container in one embodiment. And in another embodiment, adhesive 120 may comprise a drying adhesive, which may, for example, harden as a solvent of the adhesive evaporates.

Adhesive 120 may alternatively comprise a chemical-curing adhesive which may bond to the container using a chemical reaction (e.g., using a chemical catalyst, thermal catalyst, etc.). And in another embodiment, adhesive 120 may comprise a photochemical-curing adhesive which cures upon exposure to certain types of light (e.g., UV, etc.).

As shown in FIG. 1A, adhesive 120 may be applied immediately before bonding structural member 110 to the container. For example, a patch (e.g., 100) may be selected upon identifying a container which is damaged or in need of reinforcement, where the dimensions or other attributes of the patch (e.g., 100) may be determined based upon the extent, size or other characteristics of the damaged area or area to be reinforced. Alternatively, the adhesive (e.g., 120) may be applied to the structural member (e.g., 110) well before the time of application (e.g., during manufacture of patch 100). For example, a backing may be applied to the adhesive (e.g., 120) during manufacture, where the backing 10 may be removed at the time of application. In another embodiment, the adhesive may be applied during manufacture in an uncured state such that the adhesive (e.g., 120) may be catalyzed or cured (e.g., subjected to heat, light, chemicals, etc.) at the time of application.

In one embodiment, additives or reinforcing materials may be added to adhesive 120 for improving one or more physical properties of patch 100. For example, adhesive 120 may comprise dispersed particles. Alternatively, reinforcing fibers (e.g., polymer, Kevlar, carbon, glass, etc.) may be disposed in adhesive 120, thereby forming a composite material with an adhesive matrix surrounding the reinforcing fibers. And in another embodiment, thin sheets of rigid materials (e.g., rigid plastics, metals, etc.) may be applied to structural member 110 along with adhesive 120. As such, embodiments provide convenient and effective means for varying the physical properties of patch 100 by adjusting the composition of adhesive 120 in addition to or in place of changing attributes of structural member 110 as discussed above.

Although FIG. 1A depicts structural member 110 and adhesive 120 with a specific size, shape, color, etc., it should be appreciated that structural member 110 and adhesive 120 may comprise alternative sizes, shapes, colors, etc., in other embodiments. Additionally, although adhesive 120 is depicted in FIG. 1A as evenly and contiguously covering surface 115, it should be appreciated that adhesive 120 may unevenly and/or non-contiguously cover surface 115 in other embodiments. Additionally, although FIG. 1A depicts adhesive 120 as covering surface 115 without gaps, holes, etc., it should be appreciated that one or more portions of surface 115 may not be covered by adhesive 120 in other embodiments.

FIG. 1B shows exemplary surface patch 100 with an adhesive backing for repairing or reinforcing a container in accordance with one embodiment of the present invention. As shown in FIG. 1B, adhesive backing 130 may cover adhesive 120, where backing 130 may be removed (e.g., peeled off, removed, etc.) from patch 100 prior to application of the patch (e.g., 100) to a container. Backing 130 may reduce or prevent premature or unintended application of the patch to objects. Alternatively, backing 130 may reduce or prevent premature or unintended curing of adhesive 120 (e.g., prior to application of patch 100 to the container).

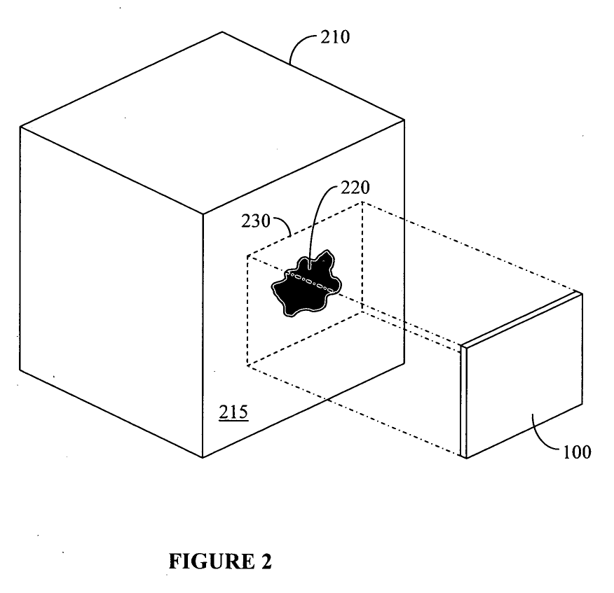

FIG. 2 shows exemplary surface patch 100 applied to container 210 in accordance with one embodiment of the present invention. Container 210 may comprise a shipping container, storage container, display container, or other container. As shown in FIG. 2, container 210 comprises area 220 on surface 215. Area 220 may comprise a rupture, puncture, defamation, or other damage/weakening to surface 215. Alternatively, area 220 may comprise an area needing reinforcement. To repair or reinforce container 210, patch 100 may be applied to surface 215 of container 210 within the area outlined by dashed lines 230. As such, patch 100 may bond to portions of surface 215 surrounding area 220 to improve the structural integrity of container 210. Additionally, patch 100 may cover and conceal area 220 to protect the contents of container 210, as well as improve the aesthetics thereof.

Container 210 may comprise a housing for storing and/or transporting one or more items, where the housing may comprise any material sufficient to carry and/or protect contents of the container. For example, container 210 may comprise cardboard in one embodiment. Alternatively, container 210 may comprise a polymer, ligneous material, non-metallic material, metallic material, or other material in other embodiments.

Although container 210 is depicted with a specific shape, size with respect to area 220 and patch 100, color, etc., it should be appreciated that container 210 may be alternatively shaped, sized, colored, etc., in other embodiments. Additionally, it should be appreciated that area 220 may comprise different shapes and/or sizes in other embodiments. It should also be appreciated that patch 100 may comprise different shapes, sizes, colors (e.g., to match, coordinate with, etc. container 210), etc. in other embodiments. And although not depicted in FIG. 2, it should be appreciated that one or more surfaces of patch 100 (e.g., those surfaces visible after application to container 210) may comprise text, logos, colors, etc. as discussed above.

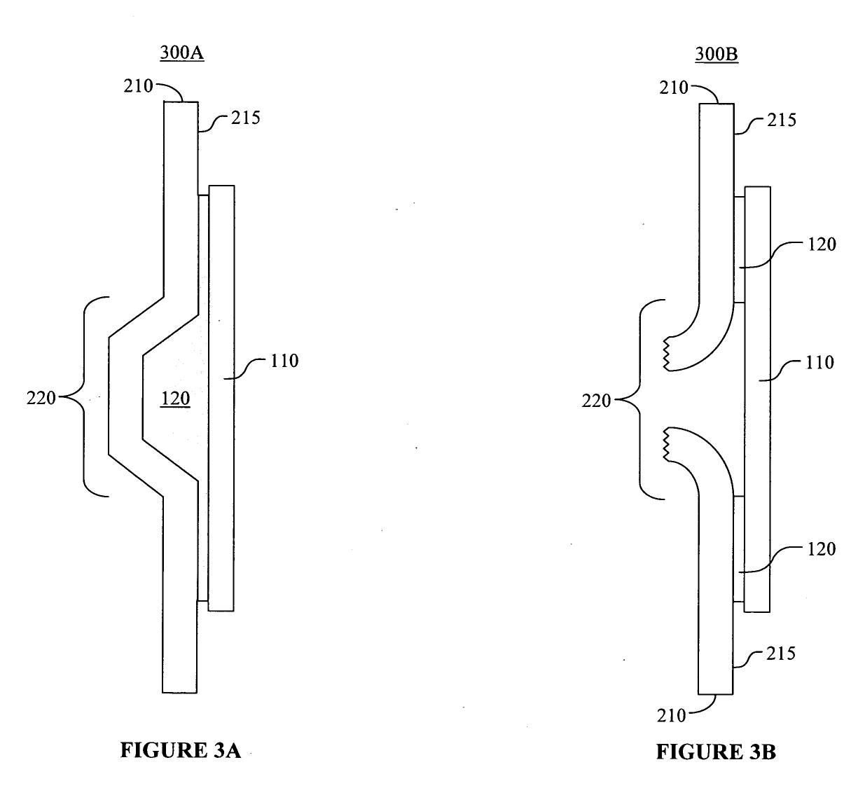

FIG. 3A shows cross-section 300A of an exemplary surface patch applied to a surface of a container in accordance with one embodiment of the present invention. As shown in FIG. 3A, area 220 may comprise a deformation or indentation in surface 215 of container 210. Structural member 110 is bonded to surface 215 of container 210 by adhesive 120, thereby covering area 220. As such, container 210 may be strengthened to compensate for any weakening in area 220. Additionally, where the damage to container 210 (e.g., in area 220) increases the susceptibility of the contents of the container to subsequent damage or loss, structural member 110 applied to surface 215 may improve the safety and/or security of the contents by at least partially covering area 220. Further, by covering area 220, structural member 110 may also improve the aesthetics of container 210.

Although FIG. 3A depicts structural member 110 applied to container 210 with a specific type of damage or weakening, it should be appreciated that structural member 110 may be applied to other types or forms of container damage/weakening in other embodiments. Additionally, it should be appreciated that structural member 110, adhesive 120, container 210, or a combination thereof, may be alternatively shaped, sized, colored, etc., in other embodiments. Further, it should be appreciated that adhesive 120 may be alternatively disposed (e.g., with gaps, voids, bubbles, etc.) between structural member 110 and container 210 in other embodiments,

FIG. 3B shows a cross-section 300B of an exemplary surface patch applied to a punctured surface of a container in accordance with one embodiment of the present invention. As shown in FIG. 3B, area 220 may comprise a puncture in surface 215 of container 210. Structural member 110 is bonded to surface 215 of container 210 by adhesive 120, thereby covering area 220. As such, container 210 may be strengthened to compensate for any weakening in area 220. Additionally, application of structural member 110 to surface 215 may improve the safety and/or security of the contents by at least partially covering area 220. Further, by covering area 220, structural member 110 may also improve the aesthetics of container 210.

Although FIG. 3B depicts structural member 110 applied to container 210 with a specific type of damage (e.g., a puncture), it should be appreciated that structural member 110 may be applied to other types or forms of container damage (e.g., a rupture, etc.) in other embodiments. Additionally, it should be appreciated that structural member 110, adhesive 120, container 210, or a combination thereof, may be alternatively shaped, sized, colored, etc., in other embodiments. Further, it should be appreciated that adhesive 120 may be alternatively disposed (e.g., with bubbles or voids, to plug the punctured area, etc.) between structural member 110 and container 210 in other embodiments.

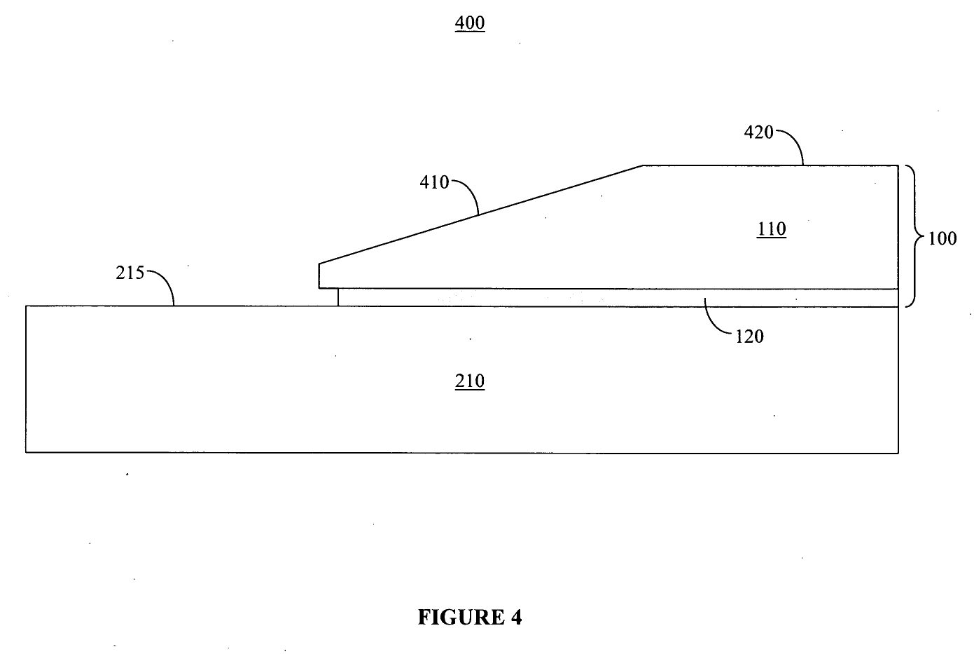

FIG. 4 shows cross-section 400 of an exemplary beveled edge of a patch for repairing or reinforcing a container in accordance with one embodiment of the present invention. As shown in FIG. 4, structural member 110 of patch 100 may comprise beveled surface 410, which provides a more streamlined transition between top surface 420 of structural member 110 and surface 215 of container 210. As such, external objects (e.g., rollers or sorting/routing mechanisms at shipping/receiving locations, floors or features of delivery vehicles, other containers, etc.) that the container may encounter during the course of a delivery may pass over or by patch 100 instead of catching or snagging patch 100, thereby reducing damage to the patch (e.g., 100) and/or further damage to the container (e.g., 210).

Although FIG. 4 depicts structural member 110, beveled surface 410, adhesive 120, and container 210 with specific shapes, sizes and colors, it should be appreciated that one or more of these elements (e.g., 100, 410, 120, 210, etc.) may comprise alternative shapes, sizes, colors, etc., in other embodiments. Additionally, although surface 410 is beveled in FIG. 4, it should be appreciated that structural member 110 may comprise one or more different features (e.g., a fillet, radius, etc.) in other embodiments.

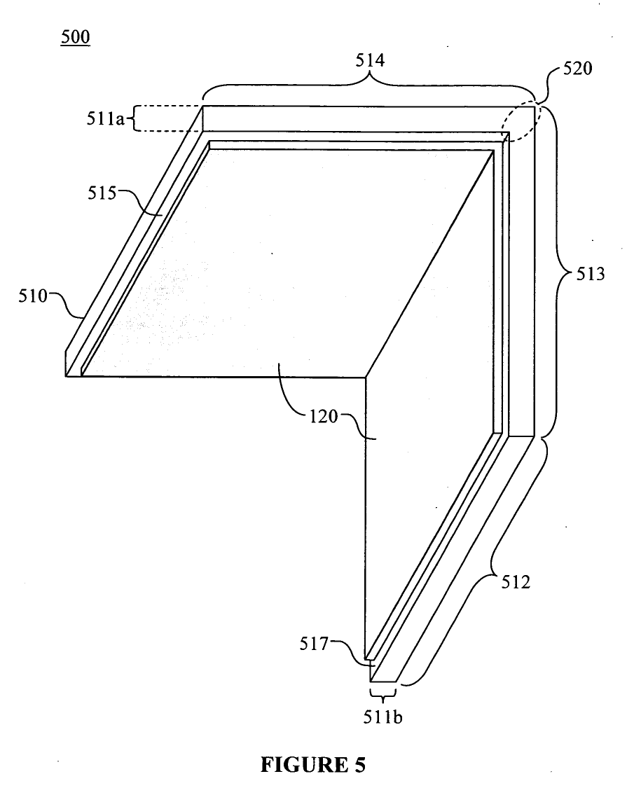

FIG. 5 shows exemplary edge patch 500 for repairing or reinforcing a container in accordance with one embodiment of the present invention. As shown in FIG. 5, exemplary edge patch 500 comprises structural member 510 with surfaces 515 and 517 for mating with surfaces (e.g., damaged surfaces, weakened surfaces, surfaces surrounding an area to be reinforced, etc.) of a container. Structural member 510 comprises bend 520 for conforming to an edge of a damaged container. Adhesive 120 is disposed on surfaces 515 and 517 for bonding structural member 510 to the container, thereby reinforcing and improving the structural integrity of the container (e.g., by limiting movement of one or more portions of the container with respect to one another in one or more directions). Additionally, patch 500 may at least partially cover damaged areas to protect the contents of the container from damage (e.g., from external objects that may penetrate the container, etc.) and/or loss (e.g., through openings created by damage to the container). Further, by at least partially concealing damage to the container, patch 500 may improve the aesthetics of the damaged container.

As depicted in FIG. 5, patch 500 may comprise a low-profile for reducing subsequent damage to the container caused by snagging or catching patch 500 on external objects. For example, heights or thicknesses 511a and/or 511b of patch 500 may be substantially less than other dimensions (e.g., 512, 513, 514, etc.) of patch 500. As such, external objects (e.g., rollers or sorting/routing mechanisms at shipping/receiving locations, floors or features of delivery vehicles, other containers, etc.) that the container may encounter during the course of a delivery may pass over or by patch 500 instead of catching or snagging patch 500, thereby reducing damage to the patch (e.g., 500) and/or further damage the container.

Additionally, patch 500 may comprise one or more beveled, filleted, or otherwise contoured edges (e.g., similar to surface 410 depicted in FIG. 4) for providing a more streamlined transition between a top surface of structural member 510 (e.g., opposing surfaces 515 and/or 517) and a container surface to which patch 500 is applied. As such, external objects (e.g., rollers or sorting/routing mechanisms at shipping/receiving locations, floors or features of delivery vehicles, other containers, etc.) that the container may encounter during the course of a delivery may pass over or by patch 500 instead of catching or snagging patch 500, thereby reducing damage to the patch (e.g., 500) and/or further damage to the container.

Structural member 510 may comprise paper-based material (e.g., cardboard, cardstock, pressboard, etc.), ligneous material (e.g., wood, faux wood, etc.), metal, polymer, composite material (e.g., sheet molded composite (SMC), fiber reinforced composites, etc.), or any combination thereof. Alternatively, structural member 510 may comprise any material providing physical properties (e.g., tensile strength, impact strength, hardness, flexibility, brittleness, etc.) sufficient for withstanding various types of loadings (e.g., tensile, compression, impact, etc.) imparted to the container (e.g., during transportation, handling, etc.).

Structural member 510 may comprise different shapes, sizes, colors, etc., thereby offering convenient and effective means for repairing or reinforcing various types of containers regardless of appearance and/or type/extent of damage, weakening, etc. In one embodiment, the color scheme of member 510 may match, coordinate with, etc., one or more containers. For example, member 510 may comprise a brown color for application to cardboard containers. Alternatively, member 510 may comprise a predetermined color scheme (e.g., specified by users, etc.). Additionally, patch 500 may comprise one or more areas designated for advertising or other communications. For example, structural member 510 may comprise the name, logo, colors, etc., of a person or entity applying the patch, thereby providing means for an aesthetic repair/reinforcement as well as an advertising opportunity for the user of the patch, a third-party, etc. And in other embodiments, patch 500 may provide one or more areas for messages (e.g., from a carrier repairing or reinforcing a container to the recipient of the shipping container, to customers for informational or advertising purposes, etc.) to be written.

Although FIG. 5 depicts adhesive 120 with a specific size, shape, color, etc., it should be appreciated that adhesive 120 may comprise alternative shapes, sizes, colors, etc., in other embodiments. Additionally, although adhesive 120 is depicted in FIG. 5 as evenly and contiguously covering surfaces 515 and 517, it should be appreciated that adhesive 120 may unevenly and/or non-contiguously cover surfaces 515 and/or 517 in other embodiments. Although FIG. 5 depicts adhesive 120 as covering surfaces 515 and 517 without gaps, holes, etc., it should be appreciated that one or more portions of surfaces 515 and 517 may not be covered by adhesive 120 in other embodiments. Further, although FIG. 5 does not show an adhesive backing applied to adhesive 120 (e.g., similar to patch 100 as depicted in FIG. 1B), it should be appreciated that an adhesive backing (e.g., similar to 130 of FIG. 1B) may be applied to adhesive 120 of patch 500 in other embodiments.

Although FIG. 5 depicts structural member 510 with a sharp bend (e.g., 520), it should be appreciated that surfaces 515 and 517 may be alternatively joined (e.g., with a radius, with multiple bends, etc.) in other embodiments. It should also be appreciated that surfaces 515 and/or 517 may be alternatively oriented with respect to one another in other embodiments.

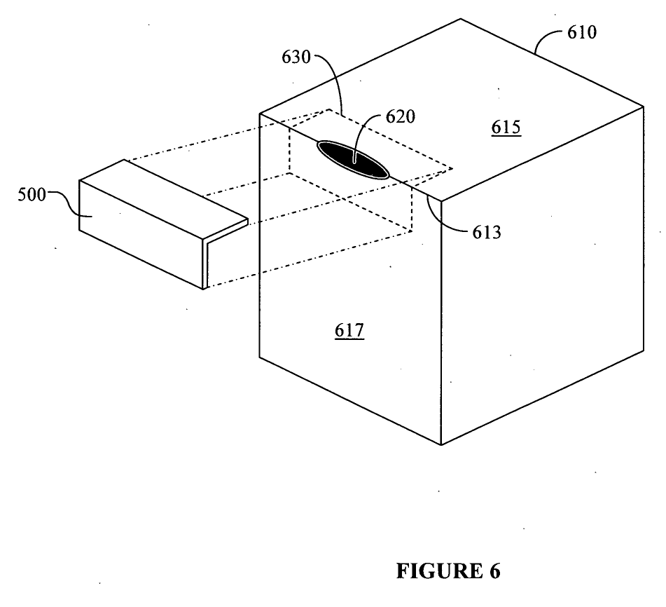

FIG. 6 shows exemplary edge patch 600 applied to container 610 in accordance with one embodiment of the present invention. Container 610 may comprise a shipping container, storage container, display container, or other container. As shown in FIG. 6, container 610 comprises area 620 along edge 613 of surfaces 615 and 617. Area 620 may comprise a rupture, puncture, defamation, or other damage to edge 613. Alternatively, area 620 may comprise an area needing reinforcement. To repair or reinforce container 610, patch 500 may be applied to surfaces 615 and 617 of container 610 within the area outlined by dashed lines 630. As such, patch 500 may bond to portions of surfaces 615 and 617 surrounding area 620 to improve the structural integrity of container 610. Additionally, patch 500 may cover and conceal area 620 to protect the contents of container 610, as well as improve the aesthetics thereof.

Container 610 may comprise a housing for storing and/or transporting one or more items, where the housing may comprise any material sufficient to carry and/or protect contents of the container. For example, container 610 may comprise cardboard in one embodiment. Alternatively, container 610 may comprise a polymer, ligneous material, non-metallic material, metallic material, or other material in other embodiments.

Although container 610 is depicted with a specific shape, size with respect to area 620 and patch 500, color, etc., it should be appreciated that container 610 may be alternatively shaped, sized, colored, etc., in other embodiments. Additionally, it should be appreciated that area 620 may comprise different shapes and/or sizes in other embodiments. It should also be appreciated that patch 500 may comprise different shapes, sizes, colors (e.g., to match, coordinate with, etc. container 610), etc. in other embodiments. And although not depicted in FIG. 6, it should be appreciated that one or more surfaces of patch 500 (e.g., those surfaces visible after application to container 610) may comprise text, logos, colors, etc. as discussed above.

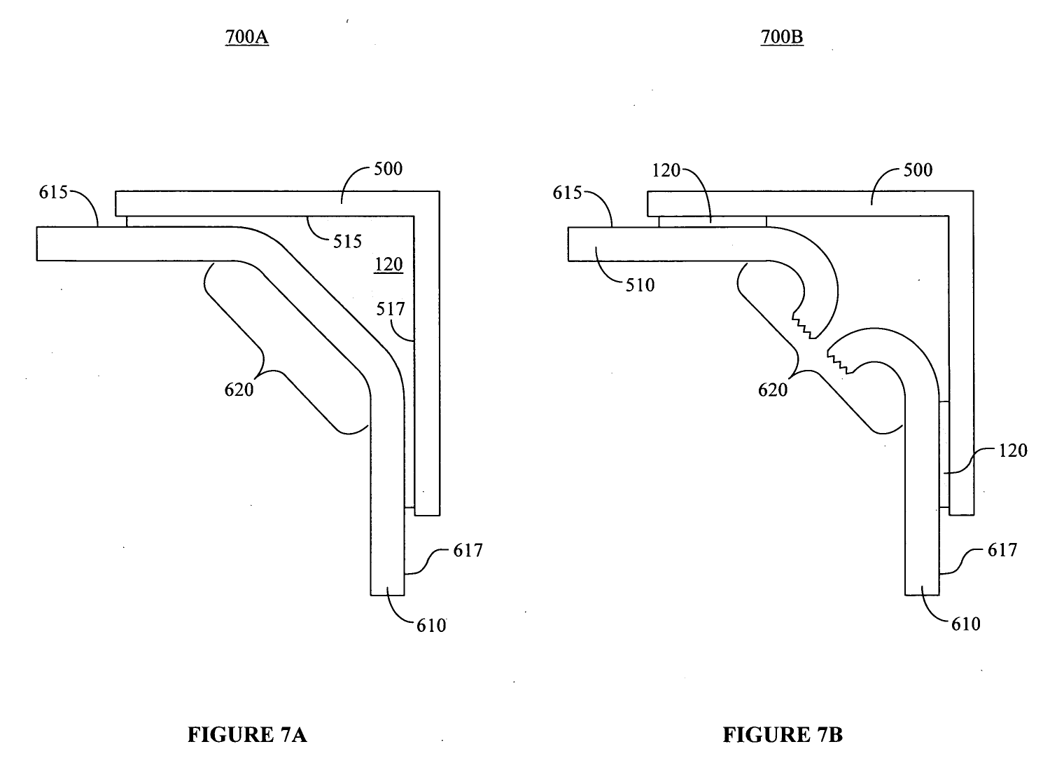

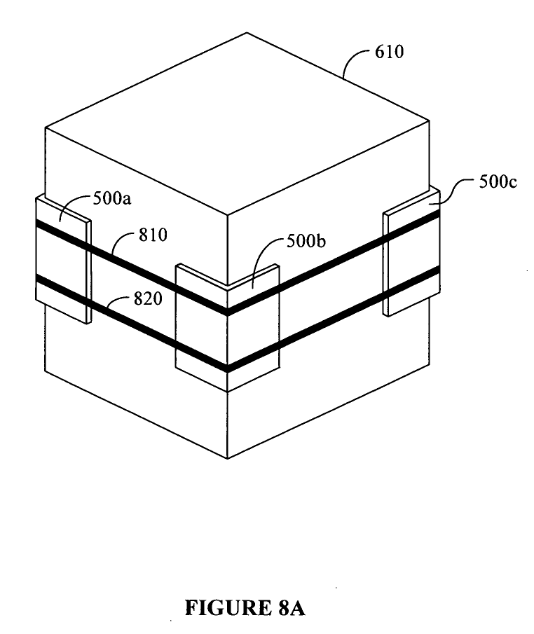

FIG. 7A shows cross-section 700A of an exemplary patch applied to an edge or corner of a container in accordance with one embodiment of the present invention. As shown in FIG. 7A, area 620 may comprise a deformation or indentation (e.g., along edge 613, a corner comprising edge 613, etc.) of surfaces 615 and/or 617 of container 610. Surfaces 515 and 517 of structural member 510 are bonded to surfaces 615 and 617 of container 610, respectively, by adhesive 120, thereby covering area 620. As such, container 610 may be strengthened to compensate for any weakening in area 620. Additionally, where the damage to container 610 (e.g., in area 620) increases the susceptibility of the contents of the container to subsequent damage or loss, structural member 510 applied to surfaces 615 and/or 617 may improve the safety and/or security of the contents by at least partially covering area 620. Further, by covering area 620, structural member 510 may also improve the aesthetics of container 610.

Although FIG. 7A depicts structural member 510 applied to container 610 with a specific type of damage, it should be appreciated that structural member 510 may be applied to other types or forms of container damage in other embodiments. Additionally, it should be appreciated that structural member 510, adhesive 120, container 610, or a combination thereof, may be alternatively shaped, sized, colored, etc., in other embodiments. Further, it should be appreciated that adhesive 120 may be alternatively disposed (e.g., with gaps, voids, bubbles, etc.) between structural member 510 and container 610 in other embodiments.

FIG. 7B shows cross-section 700B of an exemplary patch applied to a punctured edge or corner of a container in accordance with one embodiment of the present invention. As shown in FIG. 7B, area 620 may comprise a puncture (e.g., along edge 613, a corner comprising edge 613, etc.) of surfaces 615 and/or surface 617 of container 610. Surfaces 515 and 517 of structural member 510 are bonded to surfaces 615 and 617 of container 610, respectively, by adhesive 120, thereby covering area 620. As such, container 610 may be strengthened to compensate for any weakening in area 620. Additionally, application of structural member 510 to surfaces 615 and/or 617 may improve the safety and/or security of the contents by at least partially covering area 620. Further, by covering area 620, structural member 510 may also improve the aesthetics of container 610.

Although FIG. 7B depicts structural member 510 applied to container 610 with a specific type of damage (e.g., a puncture), it should be appreciated that structural member 510 may be applied to other types or forms of container damage (e.g., a rupture, etc.) in other embodiments. Additionally, it should be appreciated that structural member 510, adhesive 120, container 610, or a combination thereof, may be alternatively shaped, sized, colored, etc., in other embodiments. Further, it should be appreciated that adhesive 120 may be alternatively disposed (e.g., with bubbles or voids, to plug the punctured area, etc.) between structural member 510 and container 610 in other embodiments.

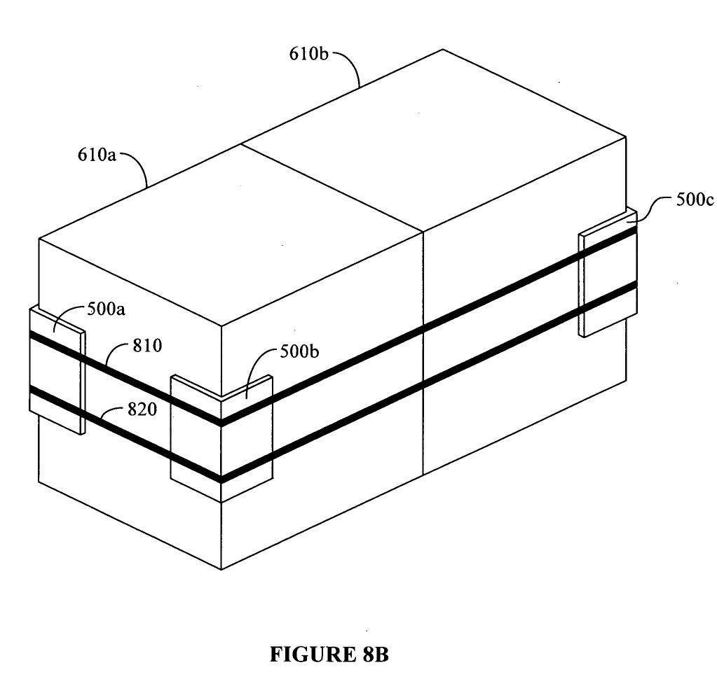

FIG. 8A shows exemplary edge patches 500a-500c for supporting straps applied to container 610 in accordance with one embodiment of the present invention. In one embodiment, one or more of patches 500a-500c may be implemented in accordance with patch 500 of FIG. 5. And in other embodiments, one or more of patches 500a-500c may be applied without adhesive (e.g., 120).

After application of the patches (e.g., 500, 500a-500c, etc.) to container 610, straps 810 and 820 (e.g., comprising a polymer, metal, etc.) may be applied over the patches (e.g., 500, 500a-500c, etc.). It should be appreciated that straps 810 and 820 may be applied to strengthen container 610, to secure container 610 to another object, etc. As such, the patches (e.g., 500, 500a-500c, etc.) may comprise dimensions (e.g., thicknesses 511a, 511b, etc.) and/or compositions for providing physical properties sufficient to withstand straps 810 and/or 820.

Although FIG. 8A depicts only three patches (e.g., 500a-500c), it should be appreciated that a larger or smaller number of patches may be used in other embodiments. Additionally, it should be appreciated that the patches (e.g., 500a-500c) may be alternatively positioned on container 610 in other embodiments. Although FIG. 8A depicts only two straps (e.g., 810 and 820), it should be appreciated that a larger or smaller number of straps may be applied to container 610 in other embodiments. Further, it should be appreciated that straps (e.g., 810, 820, etc.) applied to container 610 may be alternatively positioned in other embodiments.

FIG. 8B shows exemplary edge patches 500a-500c for supporting straps applied to multiple containers 610a-610b in accordance with one embodiment of the present invention. As shown in FIG. 8B, patches 500a-500c may function similarly when applied to multiple containers (e.g., 610a and 610b as depicted in FIG. 8B) as when they are applied to a single container (e.g., 610 as depicted in FIG. 8A). It should be appreciated that straps 810 and 820 may be applied to containers 610a and 610b to secure them to one another, to secure them to another object, etc. Thus, as described above with respect to FIG. 8A, the patches (e.g., 500, 500a-500c, etc.) may comprise dimensions (e.g., thicknesses 511a, 511b, etc.) and/or compositions for providing physical properties sufficient to withstand straps 810 and/or 820.

Although FIG. 8B depicts only three patches (e.g., 500a-500c), it should be appreciated that a larger or smaller number of patches may be used in other embodiments. Additionally, it should be appreciated that the patches (e.g., 500a-500c) may be alternatively positioned on the containers (e.g., 610a, 610b, etc.) in other embodiments. Although FIG. 8B depicts only two straps (e.g., 810 and 820), it should be appreciated that a larger or smaller number of straps may be applied to the containers (e.g., 610a, 610b, etc.) in other embodiments. Further, it should be appreciated that the straps (e.g., 810, 820, etc.) applied to the containers (e.g., 610a, 610b, etc.) may be alternatively positioned in other embodiments. And although FIG. 8B depicts only two containers (e.g., 610a and 610b), it should be appreciated that the patches (e.g., 500, 500a-500c, etc.) and straps (e.g., 810, 820, etc.) may be applied to more than two containers in other embodiments.

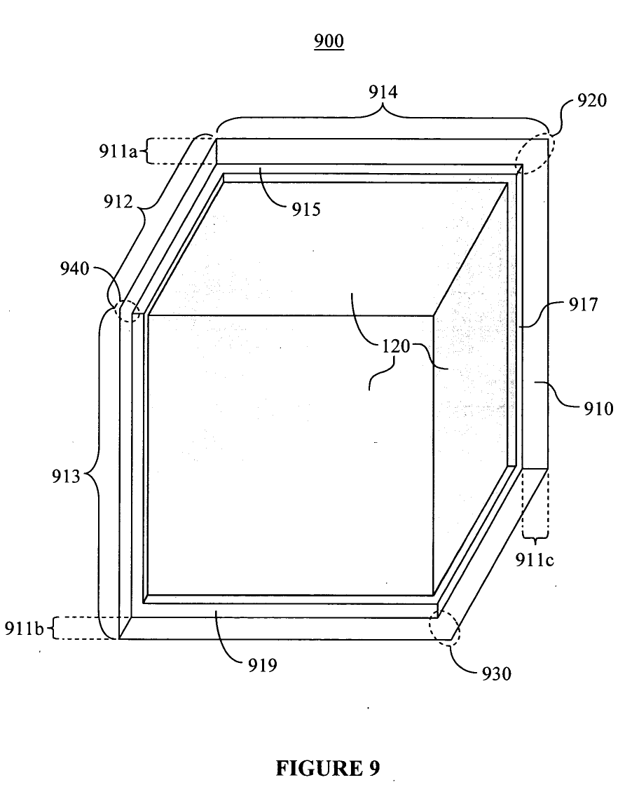

FIG. 9 shows exemplary corner patch 900 for repairing or reinforcing a container in accordance with one embodiment of the present invention. As shown in FIG. 9, exemplary corner patch 900 comprises structural member 910 with surfaces 915, 917 and 919 for mating with surfaces (e.g., damaged surfaces, weakened surfaces, surfaces surrounding an area to be reinforced, etc.) of a container (e.g., as depicted in FIGS. 7A and/or 7B). Structural member 910 comprises bends 920, 930 and 940 for conforming to a corner of a damaged container. Adhesive 120 is disposed on surfaces 915, 917 and 919 for bonding structural member 910 to the container, thereby reinforcing and improving the structural integrity of the damaged area of the container (e.g., by limiting movement of one or more portions of the container with respect to one another in one or more directions). Additionally, patch 900 may at least partially cover damaged areas to protect the contents of the container from damage (e.g., from external objects that may penetrate the container, etc.) and/or loss (e.g., through openings created by damage to the container). Further, by at least partially concealing damage to the container, patch 900 may improve the aesthetics of the damaged container.

As depicted in FIG. 9, patch 900 may comprise a low-profile for reducing subsequent damage to the container caused by snagging or catching patch 900 on external objects. For example, heights or thicknesses 911a, 911b, 911c, or a combination thereof, may be substantially less than other dimensions (e.g., 912, 913, 914, etc.) of patch 900. As such, external objects (e.g., rollers or sorting/routing mechanisms at shipping/receiving locations, floors or features of delivery vehicles, other containers, etc.) that the container may encounter during the course of a delivery may pass over or by patch 900 instead of catching or snagging patch 900, thereby reducing damage to the patch (e.g., 900) and/or further damage the container.

Additionally, patch 900 may comprise one or more beveled, filleted, or otherwise contoured edges (e.g., similar to surface 410 depicted in FIG. 4) for providing a more streamlined transition between a top surface of structural member 910 (e.g., opposing surfaces 915, 917, 919, or a combination thereof) and a container surface to which patch 900 is applied. As such, external objects (e.g., rollers or sorting/routing mechanisms at shipping/receiving locations, floors or features of delivery vehicles, other containers, etc.) that the container may encounter during the course of a delivery may pass over or by patch 900 instead of catching or snagging patch 900, thereby reducing damage to the patch (e.g., 900) and/or further damage to the container.

Structural member 910 may comprise paper-based material (e.g., cardboard, cardstock, pressboard, etc.), ligneous material (e.g., wood, faux wood, etc.), metal, polymer, composite material (e.g., sheet molded composite (SMC), fiber reinforced composites, etc.), or any combination thereof. Alternatively, structural member 910 may comprise any material providing physical properties (e.g., tensile strength, impact strength, hardness, flexibility, brittleness, etc.) sufficient for withstanding various types of loadings (e.g., tensile, compression, impact, etc.) imparted to the container (e.g., during transportation, handling, etc.).

Structural member 910 may comprise different shapes, sizes, colors, etc., thereby offering convenient and effective means for repairing or reinforcing various types of containers regardless of appearance and/or type/extent of damage, weakening, etc. In one embodiment, the color scheme of member 910 may match, coordinate with, etc., one or more containers. For example, member 910 may comprise a brown color for application to cardboard containers. Alternatively, member 510 may comprise a predetermined color scheme (e.g., specified by users, etc.). Additionally, patch 900 may comprise one or more areas designated for advertising or other communications. For example, structural member 910 may comprise the name, logo, colors, etc., of a person or entity applying the patch, thereby providing means for an aesthetic repair/reinforcement as well as an advertising opportunity for the user of the patch, a third-party, etc. And in other embodiments, patch 900 may provide one or more areas for messages (e.g., from a carrier repairing or reinforcing a container to the recipient of the shipping container, to customers for informational or advertising purposes, etc.) to be written.

Although FIG. 9 depicts adhesive 120 with a specific size, shape, color, etc., it should be appreciated that adhesive 120 may comprise alternative shapes, sizes, colors, etc., in other embodiments. Additionally, although adhesive 120 is depicted in FIG. 9 as evenly and contiguously covering surfaces 915, 917 and 919, it should be appreciated that adhesive 120 may unevenly and/or non-contiguously cover surfaces 915, 917, 919, or a combination thereof, in other embodiments. Although FIG. 9 depicts adhesive 120 as covering surfaces 915, 917 and 919 without gaps, holes, etc., it should be appreciated that one or more portions of surfaces 915, 917 and 919 may not be covered by adhesive 120 in other embodiments. Further, although FIG. 9 does not show an adhesive backing applied to adhesive 120 (e.g., similar to patch 100 as depicted in FIG. 1B), it should be appreciated that an adhesive backing (e.g., similar to 130 of FIG. 1B) may be applied to adhesive 120 of patch 900 in other embodiments.

Although FIG. 9 depicts structural member 910 with sharp bends (e.g., 920-940), it should be appreciated that surfaces 915, 917, 919 or a combination thereof, may be alternatively joined (e.g., with a radius, with multiple bends, etc.) in other embodiments. It should also be appreciated that surfaces 915, 917, 919, or a combination thereof, may be alternatively oriented with respect to one another in other embodiments.

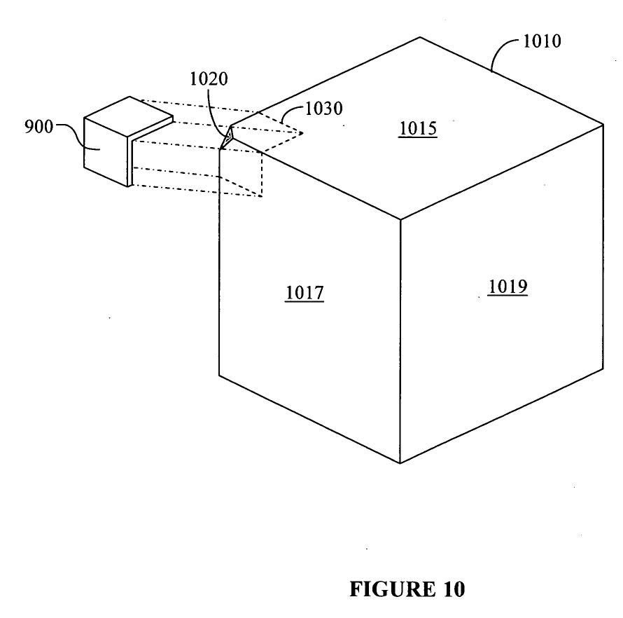

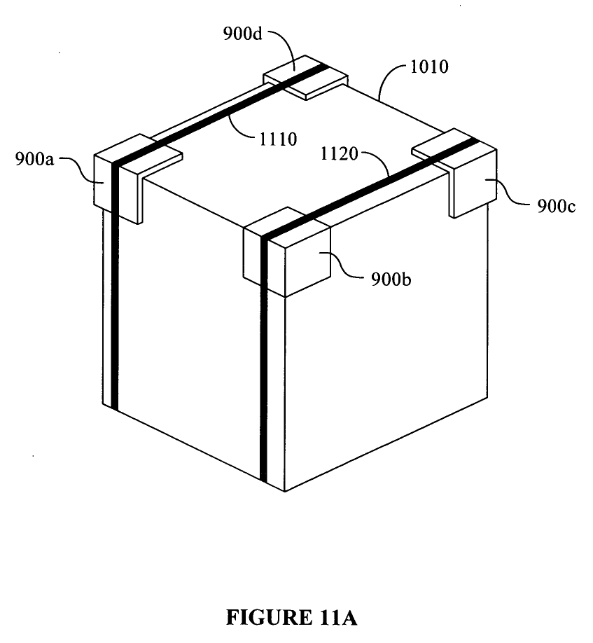

FIG. 10 shows exemplary corner patch 900 applied to container 1010 in accordance with one embodiment of the present invention. Container 1010 may comprise a shipping container, storage container, display container, or other container. As shown in FIG. 10, container 1010 comprises area 1020 which may comprise a rupture, puncture (e.g., as depicted in FIG. 7B), defamation (e.g., as depicted in FIG. 7A), or other damage to a corner. Alternatively, area 1020 may comprise an area needing reinforcement. To repair or reinforce container 1010, patch 900 may be applied to surfaces (e.g., 1015, 1017 and the surface opposing surface 1019 and not shown in FIG. 10) of container 1010 within the area outlined by dashed lines 1030. As such, patch 900 may bond to portions of the surfaces (e.g., 1015, 1017 and the surface opposing surface 1019 and not shown in FIG. 10) surrounding area 1020 to improve the structural integrity of container 1010. Additionally, patch 900 may cover and conceal area 1020 to protect the contents of container 1010, as well as improve the aesthetics thereof.

Container 1010 may comprise a housing for storing and/or transporting one or more items, where the housing may comprise any material sufficient to carry and/or protect contents of the container. For example, container 1010 may comprise cardboard in one embodiment. Alternatively, container 1010 may comprise a polymer, ligneous material, non-metallic material, metallic material, or other material in other embodiments.

Although container 1010 is depicted with a specific shape, size with respect to area 1020 and patch 900, color, etc., it should be appreciated that container 1010 may be alternatively shaped, sized, colored, etc., in other embodiments. Additionally, it should be appreciated that area 1020 may comprise different shapes and/or sizes in other embodiments. It should also be appreciated that patch 900 may comprise different shapes, sizes, colors (e.g., to match, coordinate with, etc. container 1010), etc. in other embodiments. And although not depicted in FIG. 10, it should be appreciated that one or more surfaces of patch 900 (e.g., those surfaces visible after application to container 1010) may comprise text, logos, colors, etc. as discussed above.

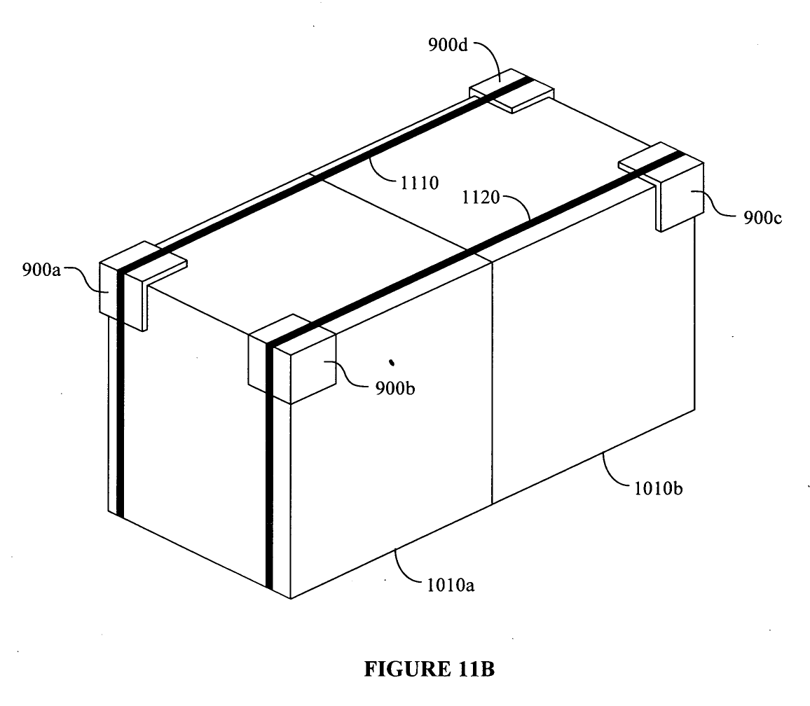

FIG. 11A shows exemplary corner patches 900a-900d for supporting straps applied to container 1010 in accordance with one embodiment of the present invention. In one embodiment, one or more of patches 900a-900d may be implemented in accordance with patch 900 of FIG. 9. And in other embodiments, one or more of patches 900a-900d may be applied without adhesive (e.g., 120).

After application of the patches (e.g., 900, 900a-900d, etc.) to container 1010, straps 1110 and 1120 (e.g., comprising a polymer, metal, etc.) may be applied over the patches (e.g., 900, 900a-900d, etc.). It should be appreciated that straps 1110 and 1120 may be applied to strengthen container 1010, to secure container 1010 to another object, etc. As such, the patches (e.g., 900, 900a-900d, etc.) may comprise dimensions (e.g., thicknesses 911a, 911b, 911c, etc.) and/or compositions for providing physical properties sufficient to withstand straps 1110 and/or 1120.

Although FIG. 11A depicts only four patches (e.g., 900a-900d), it should be appreciated that a larger or smaller number of patches may be used in other embodiments. Additionally, it should be appreciated that the patches (e.g., 900a-900d) may be alternatively positioned on container 1010 in other embodiments. Although FIG. 9A depicts only two straps (e.g., 1110 and 1120), it should be appreciated that a larger or smaller number of straps may be applied to container 1010 in other embodiments. Further, it should be appreciated that straps (e.g., 1110, 1120, etc.) applied to container 1010 may be alternatively positioned in other embodiments.

FIG. 11B shows exemplary edge patches 900a-900d for supporting straps applied to multiple containers 1010a-1010b in accordance with one embodiment of the present invention. As shown in FIG. 11B, patches 900a-900d may function similarly when applied to multiple containers (e.g., 101a and 1010b as depicted in FIG. 11B) as when they are applied to a single container (e.g., 1010 as depicted in FIG. 11A). It should be appreciated that straps 1110 and 1120 may be applied to containers 1010a and 1010b to secure them to one another, to secure them to another object, etc. Thus, as described above with respect to FIG. 11A, the patches (e.g., 900, 900a-900d, etc.) may comprise dimensions (e.g., thicknesses 911a, 911b, 911c, etc.) and/or compositions for providing physical properties sufficient to withstand straps 1110 and/or 1120.

Although FIG. 11B depicts only four patches (e.g., 900a-900d), it should be appreciated that a larger or smaller number of patches may be used in other embodiments. Additionally, it should be appreciated that the patches (e.g., 900a-900d) may be alternatively positioned on the containers (e.g., 1010a, 1010b, etc.) in other embodiments. Although FIG. 11B depicts only two straps (e.g., 1110 and 1120), it should be appreciated that a larger or smaller number of straps may be applied to the containers (e.g., 1010a, 1010b, etc.) in other embodiments. Further, it should be appreciated that the straps (e.g., 1110, 1120, etc.) applied to the containers (e.g., 1010a, 1010b, etc.) may be alternatively positioned in other embodiments. And although FIG. 11B depicts only two containers (e.g., 1010a and 1010b), it should be appreciated that the patches (e.g., 900, 900a-900d, etc.) and straps (e.g., 1110, 1120, etc.) may be applied to more than two containers in other embodiments.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. An apparatus comprising:
a substantially planar structural member comprising a surface for coupling with a container;
adhesive disposed on said surface for coupling said substantially planar structural member to said container; and
wherein said substantially planar structural member is operable to overlap a damaged portion of said container and further operable to improve the structural integrity of said container.

2. The apparatus of claim 1, wherein said substantially planar structural member is further operable to protect contents within said container.

3. The apparatus of claim 1, wherein said adhesive comprises at least one of dispersed particles and reinforcing fibers.

4. The apparatus of claim 1, wherein at least one edge of said substantially planar structural member comprises a beveled surface.

5. The apparatus of claim 1, wherein a thickness of said substantially planar structural member is significantly less than at least one of a length and a width of said substantially planar structural member.

6. The apparatus of claim 1, wherein said adhesive comprises at least one of a pressure-sensitive adhesive, a thermoplastic adhesive, a contact adhesive, a drying adhesive, a chemical-curing adhesive, and a photochemical-curing adhesive.

7. The apparatus of claim 1, wherein said damaged container comprises at least one of cardboard, polymer, ligneous material, and a non-metallic material.

8. The apparatus of claim 1 further comprising:
a removable backing disposed on said adhesive for removal prior to application to said container.

9. An apparatus comprising:
a structural member comprising at least one surface for coupling with at least two surfaces of a container;
adhesive disposed on said at least one surface for coupling said structural member to said container; and
wherein said structural member is operable to overlap a damaged portion of said container and further operable to improve the structural integrity of said container.

10. The apparatus of claim 9, wherein said damaged portion comprises an edge of said container.

11. The apparatus of claim 9, wherein said damaged portion comprises a corner of said container.

12. The apparatus of claim 9, wherein said structural member is further operable to protect contents within said container.

13. The apparatus of claim 9, wherein said structural member comprises at least one bend for conforming to said container.

14. The apparatus of claim 9, wherein said adhesive comprises at least one of dispersed particles and reinforcing fibers.

15. The apparatus of claim 9, wherein at least one edge of said structural member comprises a beveled surface.

16. The apparatus of claim 9, wherein said adhesive comprises at least one of a pressure-sensitive adhesive, a thermoplastic adhesive, a contact adhesive, a drying adhesive, a chemical-curing adhesive, and a photochemical-curing adhesive.

17. The apparatus of claim 9, wherein said container comprises at least one of cardboard, polymer, ligneous material, and a non-metallic material.

18. The apparatus of claim 9 further comprising:
a removable backing disposed on said adhesive for removal prior to application to said container.

19. A container comprising:
a housing operable to store one or more items therein, said housing comprising at least one portion; and
an apparatus coupled to said housing and overlapping said portion for improving the structural integrity of said housing, wherein said apparatus comprises adhesive disposed on a structural member of said apparatus for coupling said structural member to at least one surface of said housing.

20. The container of claim 19, wherein said portion comprises a damaged portion of said housing.

21. The container of claim 19, wherein said portion comprises at least one of a surface, an edge, and a corner of said housing.

22. The container of claim 19, wherein said structural member comprises at least one bend for conforming to said housing.

23. The container of claim 19, wherein at least one edge of said structural member comprises a chamfer.

24. The container of claim 19, wherein said adhesive comprises at least one of a pressure-sensitive adhesive, a thermoplastic adhesive, a contact adhesive, a drying adhesive, a chemical-curing adhesive, and a photochemical-curing adhesive.

25. The container of claim 19, wherein said housing comprises at least one of cardboard, polymer, ligneous material, and a non-metallic material.

26. An apparatus comprising:
a structural member comprising at least one surface for coupling with at least two surfaces of a container;
adhesive disposed on said at least one surface for coupling said structural member to said container; and
wherein said structural member is operable to overlap a portion of said container and further operable to improve the structural integrity of said container.

27. The apparatus of claim 26, wherein said portion comprises an edge of said container.

28. The apparatus of claim 26, wherein said portion comprises a corner of said container.

29. The apparatus of claim 26, wherein said structural member comprises at least one bend for conforming to said container.

30. The apparatus of claim 26, wherein at least one edge of said structural member comprises a beveled surface.

31. The apparatus of claim 26, wherein said adhesive comprises at least one of a pressure-sensitive adhesive, a thermoplastic adhesive, a contact adhesive, a drying adhesive, a chemical-curing adhesive, and a photochemical-curing adhesive.

32. The apparatus of claim 26, wherein said container comprises at least one of cardboard, polymer, ligneous material, and a non-metallic material.

33. The apparatus of claim 26 further comprising:
a removable backing disposed on said adhesive for removal prior to application to said container.
